(19) United States
(12) Patent Application Publication
(10) Pub. No.: US 2021/0072966 A1
(43) Pub. Date: Mar. 11, 2021

(54) METHOD AND SYSTEM FOR SERVICE ROLLING-UPDATING IN A CONTAINER ORCHESTRATOR SYSTEM

(71) Applicant: International Business Machines Corporation, Armonk, NY (US)

(72) Inventors: Dong Jun Zong, Beijing (CN); Yue Wang, Beijing (CN); Da Li Liu, Beijing (CN); Qi Feng Huo, Beijing (CN); Jing Xing, Beijing (CN); Jian Fang Zhang, Beijing (CN); Jing Hu Liu, Beijing (CN); Wen Tao Zhang, Beijing (CN)

(21) Appl. No.: 16/561,591

(22) Filed: Sep. 5, 2019

(51) Int. Cl. G06F 8/65; H04L 29/08

(52) U.S. Cl. CPC G06F 8/65; H04L 67/34

(57) ABSTRACT

It is disclosed a computer-implemented method, a computing system, and a computer program product for service rolling-updating at a node in a container orchestrator system. In the method, in response to an instruction to update a service deployed on a first pod of a plurality of pods, a second pod is created at the node. The service is deployed on each of the plurality of pods at the node. A rule indicating that a set of requests for the service deployed on the first pod are to be routed to the second pod is generated. The first pod is deleted from the node. The set of requests are routed to the second pod according to the rule.

### BACKGROUND

The present invention relates to a service updating technology, and more specifically, to a method, a system and a computer program product for service rolling-updating in a container orchestrator system.

Software applications are becoming increasingly sophisticated in all kinds of technical arts, and the complexity of the software applications also increases, as the number of underlying components increases. The software applications implement all kinds of services requested by a large number of end devices. The services may include live video, multiparty call, bank communication, video meeting, micro-blog, etc.

When a service is updated, there is a need for service updating technology to keep the end devices enjoying the service continuously.

Container orchestration is the automated configuration, coordination, and management of computer systems and software that relate to containers (for example, container images, deployment of new container instantiations, running container instantiations). One common container orchestration tool is called Kubernetes. Container orchestration typically manages the lifecycles of containers, especially in large, dynamic environments. Many tasks may be automated by container orchestration software, such as: provisioning and deployment of containers; redundancy and availability of containers; scaling up or removing containers to spread application load evenly across host infrastructure; movement of containers from one host to another if there is a shortage of resources in a host, or if a host dies; allocation of resources between containers; external exposure of services running in a container with the outside world; load balancing of service discovery between containers; health monitoring of containers and hosts; and/or configuration of an application in relation to the containers running it. When one uses a container orchestration tool, one typically describes the configuration of an application in a YAML or JSON file, depending on the orchestration tool. These configurations files (for example, docker-compose.yml) are where you tell the orchestration tool where to gather container images (for example, from Docker Hub), how to establish networking between containers, how to mount storage volumes, and where to store logs for that container. Once the container is running on the host, the orchestration tool manages its lifecycle according to the specifications you laid out in the container's definition file.

### SUMMARY

According to one embodiment of the present invention, provided is a computer-implemented method for service rolling-updating at a node in a container orchestrator system. In the method, in response to an instruction to update a service deployed on a first pod of a plurality of pods, a second pod is created at the node. The service is deployed on each of the plurality of pods at the node. A rule, indicating that a set of requests for the service deployed on the first pod is to be routed to the second pod, is generated. The first pod is deleted from the node. The set of requests are routed to the second pod according to the rule.

According to another embodiment of the present invention, there is provided a computing system for service rolling-updating in a container orchestrator system. The computing system includes one or more processing units and a memory coupled to the one or more processing units. A set of computer program instructions is stored in the memory, which when executed by the one or more processing units, perform a computer-implemented method for service rolling-updating at a node in a container orchestrator system. In the method, in response to an instruction to update a service deployed on a first pod of a plurality of pods, a second pod is created at the node. The service is deployed on each of the plurality of pods at the node. A rule, indicating that a set of requests for the service deployed on the first pod is to be routed to the second pod, is generated. The first pod is deleted from the node. The set of requests are routed to the second pod according to the rule.

According to another embodiment of the present invention, there is provided a computer program product comprising computer readable instructions, when executed, performs a computer-implemented method for service rolling-updating at a node in a container orchestrator system. In the method, in response to an instruction to update a service deployed on a first pod of a plurality of pods, a second pod is created at the node. The service is deployed on each of the plurality of pods at the node. A rule, indicating that a set of requests for the service deployed on the first pod are to be routed to the second pod, is generated. The first pod is deleted from the node. The set of requests are routed to the second pod according to the rule.

Additional technical features and benefits are realized through the techniques of the present invention. Embodiments and aspects of the present invention are described in detail herein and are considered a part of the claimed subject matter. For a better understanding, refer to the detailed description and to the drawings.

### BRIEF DESCRIPTION OF THE SEVERAL VIEWS OF THE DRAWINGS

Through the more detailed description of some embodiments of the present invention in the accompanying drawings, the above and other objects, features and advantages of the present invention will become more apparent, wherein the same reference generally refers to the same components in the embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a structural diagram of a container orchestrator system for service rolling-updating according to embodiments of the present invention.

FIGS. 5A-5D depict an observed problem by using a conventional rolling-update technology.

FIG. 6 depicts a flowchart of a method for service rolling-updating by a container orchestrator system as shown in FIG. 4 according to embodiments of the present invention.

FIGS. 7A-7D depict an effect by using technologies implemented by the embodiments of the present invention.

FIG. 8 depicts a flowchart of a computer-implemented method for service rolling-updating at a node in a container orchestrator system according to an embodiment of the present invention.

### DETAILED DESCRIPTION

Some embodiments will be described in more detail with reference to the accompanying drawings, in which the embodiments of the present invention have been illustrated. However, the present invention can be implemented in various manners, and thus should not be construed to be limited to the embodiments disclosed herein.

It is to be understood that although this invention includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (for example, mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify a location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

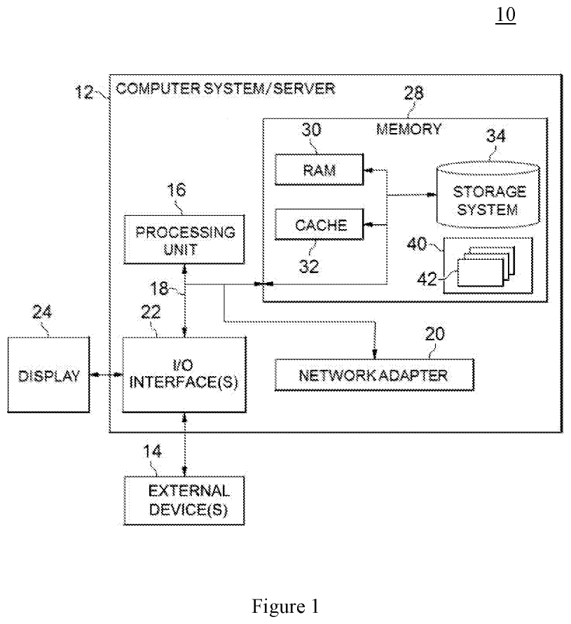

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (for example, a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (for example, at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (for example, network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (for example, the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

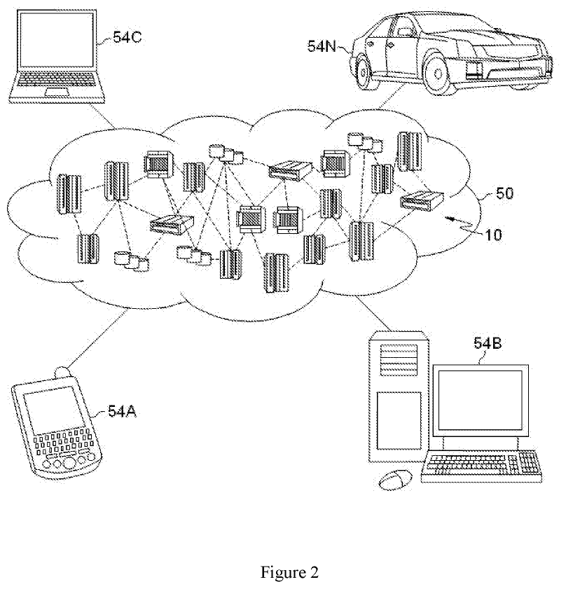

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (for example, using a web browser).

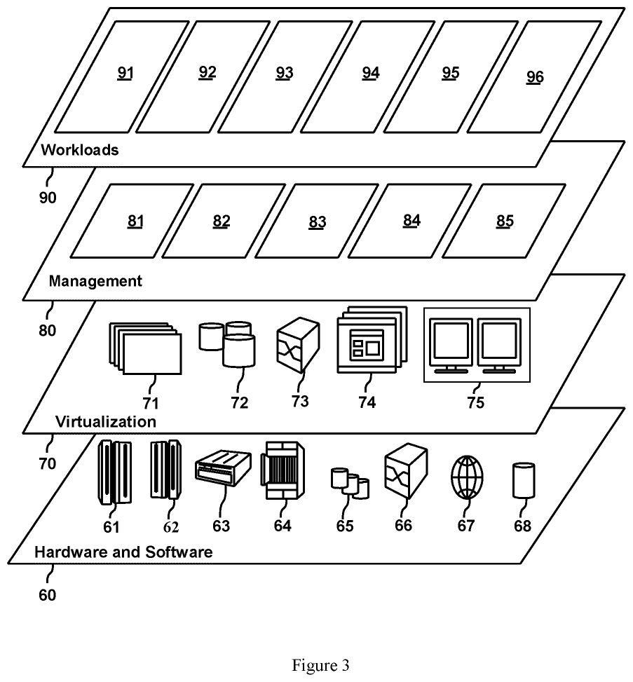

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and service rolling-updating 96.

FIG. 4 depicts a container orchestrator system for service rolling-updating according to embodiments of the present invention. The container orchestrator system is used for deploying and managing services.

A system 400 as shown in FIG. 4 includes a master node 400B (referred to as a master below) and one or more nodes including a node 400A.

A node may be a virtual or a physical machine. The node 400A includes one or more pods, for example, pod 1, pod 2 . . . and pod N (N is an integer). A pod is a container abstraction including one or more containers. The containers included in one pod can share resources. The shared resources may include storage and networking information such as IP addresses or a range of ports. After receiving a request from an end device for a service, the requested service may be deployed on each of a plurality of pods at the node. The service may include live video, multiparty call, bank communication, video meeting, and micro-blog etc., which may be a real-time service or a non-real-time service. The type of the service is not a limitation on the present invention.

The master 400B may be a virtual or a physical machine. The master is used for managing the nodes. The master 400B may receive instructions from an administrator. The master may send instructions to the node to create or delete one or more pods.

The master 400B may include an Application Programming Interface (API) 406 for interfacing with an administrator, a scheduler 407 for scheduling pods to the node 400A, and a controller manager 408 for managing the node 400A. The controller manager 408 may instruct the node 400A to create a pod or delete a pod. The controller manager 408 further includes a rule manager 409 for instructing the node 400A to create or delete a rule.

The node 400A may include an ingress gateway 401 which routes incoming requests for a service from end devices to pods. The ingress gateway 401 further includes a request identification module 402 which generates a set of unique IDs of a set of incoming requests. Each of the set of unique IDs corresponds to one of the set of incoming requests. The node 400A further includes a pilot 403 for creating or deleting a rule in response to an instruction from the rule manager 409. The node 400A further includes a Mixer 404 which stores correspondence relationships between the requests and the pods. The node 400A further includes a controller 405 which creates a pod or deletes a pod in response to an instruction from the controller manager 408.

The node 400A and the master 400B may be implemented on a plurality of cloud computing nodes.

When updating a service deployed on each of a plurality of pods, a conventional “rolling-update” technology is used. The conventional rolling-update technology allows the service to be updated with zero downtime by incrementally updating pods with new ones.

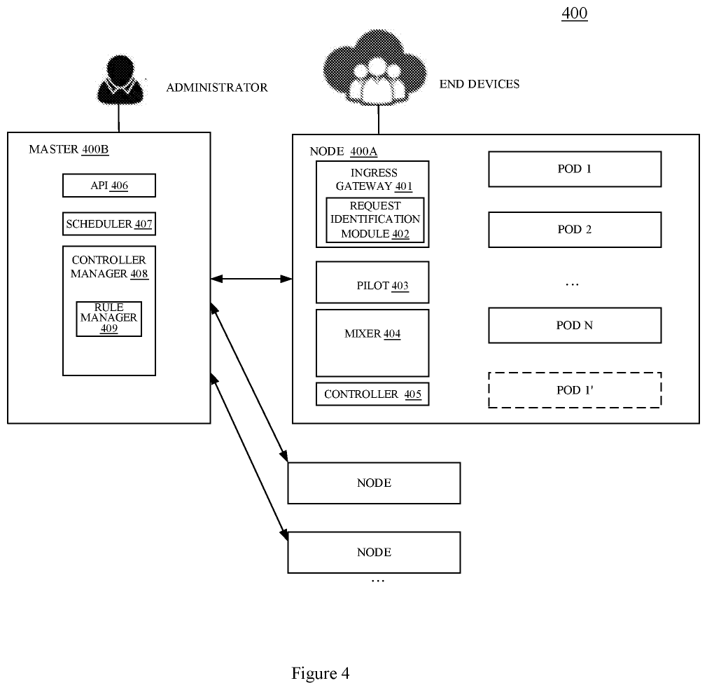

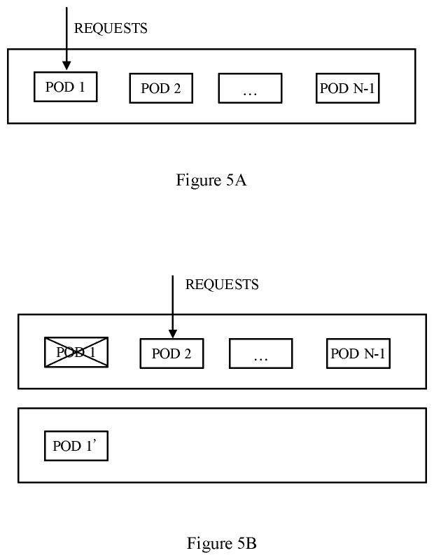

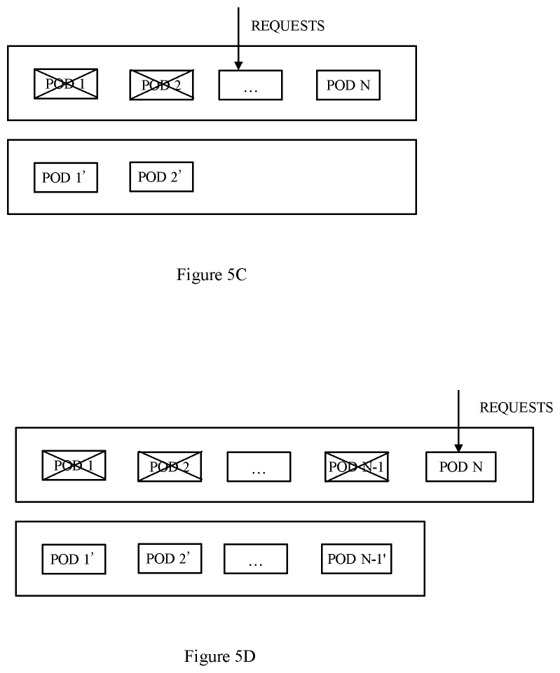

FIGS. 5A-5D depict an observed problem by using a conventional rolling-update technology.

The service requested by multiple end devices is deployed on pod 1, pod2, . . . , and pod N, so that each of pods can provide the service to the multiple end devices. The service may be load-balanced among available pods. Conventionally, a load-balance strategy may include Random, RoundRobin, ConsistentHash, Hash, and Weighted. The exact strategy can be indicated in a predetermined rule in the pilot 403. Take the Random strategy for an example below.

In order to update the service without affecting the service's availability, in the conventional “rolling-update” technology, the maximum number of pods that can be deleted is one at a time, and the maximum number of new pods that can be created is one at a time. That is, after one new pod is created, one old pod is deleted. Then, after a next new pod is created, a next old pod is deleted, etc. In other cases, the maximum numbers may be two or any number, as long as not all the pods are deleted or created at a time.

As shown in FIG. 5A, a video stream service is deployed on a pod 1, 2, . . . and pod N-1. After some time, the video stream service deployed on pods 1, 2, . . . and pod N-1 are updated sequentially. When the pod 1 is updated, a new pod 1′ is created, then the pod 1 is deleted. In FIG. 5B, the request for the service originally deployed on pod 1 may be randomly routed to a pod, such as a pod 2. Then, when the pod 2 is updated, a pod 2′ is created, then the pod 2 is deleted. As shown in FIG. 5C, in this way, the request may be randomly routed to a pod, such as a pod 3 (not shown), and so on. Finally, when the pod N-1 is updated, after a pod N-1′ is created, the pod N-1 is deleted. As shown in FIG. 5D, the request may be randomly routed to a pod, such as a pod N. In this case, during one updating round of the rolling update, the service is interrupted several times.

With the conventional rolling-update technology above, when updating a service deployed on a first pod, it is more likely to route the request to a second pod which is to be deleted soon. After the second pod is deleted, the request has to be routed to another pod again. Thus, the service may be interrupted several times. If the service is a long video stream service, the user experience may be bad due to frequent interruption. Therefore, there is a need to improve user experience during the service rolling-update.

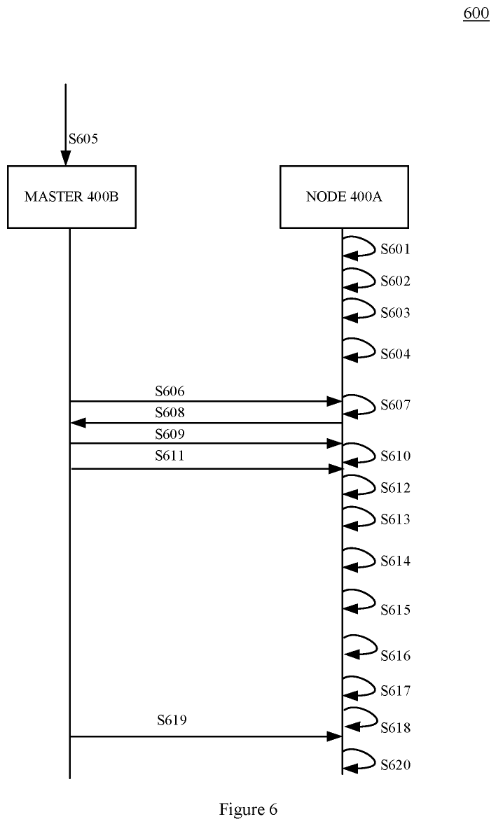

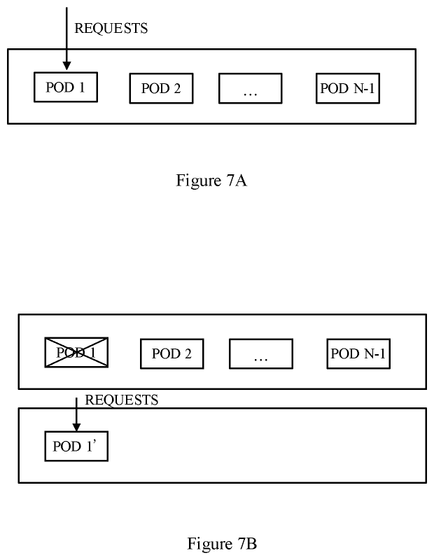

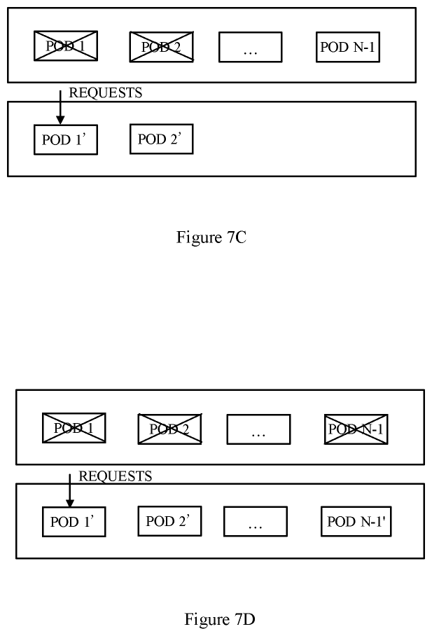

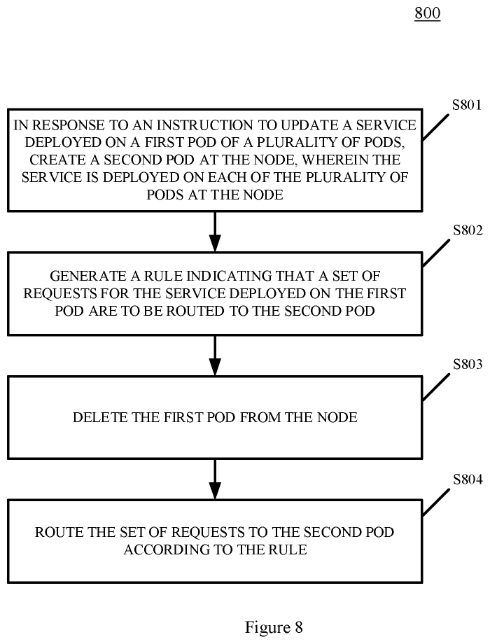

FIG. 6 depicts a flowchart of a method 600 for service rolling-updating by a container orchestrator system as shown in FIG. 4. FIGS. 7A-7D depict an effect by using technologies implemented by the embodiments of the present invention.

The node 400A includes a plurality of pods, such as pod 1, pod 2, . . . , pod N as shown in FIG. 4. A service is deployed on each of the plurality of pods at the node 400A. Each pod normally may include two containers, in other words, a proxy container and a pod container. The proxy container is configured to interface the pod container with outside.

At S601, the node 400A may receive a set of requests for a service from a plurality of end devices.

As shown in FIG. 4, before node 400A routes the set of requests to a pod, at S602, the request identification module 402 in the node 400A may generate a set of unique identifiers (IDs) corresponding to each of the set of requests, to uniquely identify each of the requests. Each of the set of unique IDs corresponds to one of the set of requests.

For example, a request may be in a format of Real Time Messaging Protocol (RTMP) with a Uniform Resource Locator (URL) “rtmp://aaa/bbb/ccc” or in a format of Hyper Text Transfer Protocol (HTTP) with a URL “http://aaa/bbb/ccc”, in this case, the request identification module 402 may generate a unique ID based on the URL of the request by using a predefined algorithm.

At S603, the node 400A may route the set of requests to, for example, a first pod of the plurality of pods, according to a rule. This rule may be any conventional rule or any newly created rule.

In one embodiment, the request identification module 402 in the node 400A may add a unique ID to a corresponding request. In one embodiment, the unique ID may be added to a header of the corresponding request. Then the request including the header may be routed to a first pod, such as a pod 1, as shown in FIG. 7A.

At S604, the node 400A may record a correspondence relationship between the set of requests and the first pod 1, for example, by recording the unique IDs of the set of requests.

In one embodiment, the proxy container of the pod 1 may check the header of the request to get the unique ID of the request and record a correspondence relationship between the unique ID and the pod 1 in a mapping table. The mixer 404 may maintain the mapping table.

At a certain time, an administrator may want to update the service deployed on the plurality of pods. For example, the administrator may instruct the master 400B to update the service from, for example, version v1 to version v2 via the API 406.

At S605, an instruction may be issued by the administrator to the master 400B to update the service. The instruction may also be issued automatically by an administrator system periodically.

At S606, in response to the instruction from the administrator, the master 400B may issue an instruction to the node 400B to create a second pod 1′, as shown in FIG. 4.

In one embodiment, in response to the instruction from the administrator, the API 406 may transfer the instruction to the scheduler 407. The scheduler 407 may schedule the controller manager 408 to issue an instruction to the controller 405 in the node 400A. The instruction instructs the controller 405 to create a new, second pod 1′ in the node 400A.

At S607, in response to the instruction from the master 400B, the node 400A may create a second pod 1′ at the node 400A, as shown in FIG. 4. Similarly, the second pod 1′ includes a proxy container and a pod container. Then the second pod 1′ is successfully created and ready for deploying a service. Then, the first pod 1 is about to be deleted.

At S608, the node 400A may issue a notification that the first pod 1 is to be deleted to the master 400B. In one embodiment, the controller 405 may issue the notification to the rule manager 409.

At S609, in response to receiving the notification, the master 400B may issue an instruction to the node 400A to generate a rule indicating that the set of requests for the service deployed on the first pod 1 are to be routed to the second pod 1′. In one embodiment, the rule manager 409 may instruct the pilot 403 to create the rule.

At S610, in response to receiving the instruction from the master 400B, the node 400A may generate a rule indicating that the set of requests for the service deployed on the first pod 1 are to be routed to the second pod. The rule may include the IDs corresponding to the set of requests.

For example, if the unique ID of the pod 1 is UniqueId1, and the pilot 403 may create the rule as an example below:

### If

### UniqueId 1

### Then

target pod is pod 1′

As above, the rule includes the unique ID of the pod 1, in other words, UniqueId1.

In another embodiment, instead of instructing the pilot 403, the rule manager 409 may create the rule itself, and report the rule to the pilot 403 as necessary.

After monitoring that the rule is created, at S611, the master 400B may issue an instruction to the node 400A to delete the first pod 1. In one embodiment, the controller manager 408 may instruct the controller 405 to delete the first pod 1 from the node 400A.

At S612, in response to the instruction from the master 400B, the node 400A may delete the first pod 1. In one embodiment, the controller 405 may delete the first pod 1.

After the first pod 1 is deleted, the set of requests for the service are retransmitted from the end devices to the node 400A. At the same time, one or more requests including at least one of the retransmitted requests and other requests may come to the node 400A. At S613, the one or more requests may be received at the node 400A.

At S614, in response to receiving the one or more requests, the node 400A may generate one or more unique IDs corresponding to each of the one or more requests. Each of the one or more unique IDs corresponds to one of the one or more requests. In one embodiment, the request identification module 402 may generate unique IDs for the requests and add the unique IDs to the requests.

At S615, the node 400A may identify the retransmitted requests, for example, by determining whether the IDs are included in the created rule. In one embodiment, the pilot 403 may determine whether the IDs are included in the rule.

At S616, if the at least one of the retransmitted requests is identified, the at least one retransmitted request may be routed to the second pod 1′ according to the rule, as shown in FIG. 7B.

At S617 the requests, other than the retransmitted requests, may be routed to any pod according to a predetermined routing rule. The predetermined routing rule may be a random routing rule, or a round-robin rule or other rules.

At S618, the node 400A may record a correspondence relationship between the at least one retransmitted request and the second pod 1′, for example, by recording the at least one ID of the at least one retransmitted request. In one embodiment, the proxy container of second pod 1′ may record a correspondence relationship between the at least one request and the second pod 1′ in a mapping table.

At S619, the master 400B may issue an instruction to the node 400A to delete the created rule, because the rule is no longer used. In one embodiment, the rule manager 409 may instruct the pilot 403 to delete the created rule.

At S620, in response to receiving the instruction, the node 400A may delete the created rule. In one embodiment, the created rule may be deleted by the pilot 403.

After that, the service deployed on the pods 2, . . . , N-1 may be updated sequentially, then pods 2′, . . . , N-1′ may be created one by one. As the retransmitted requests have been rerouted to the second pod 1′, they are not rerouted again among the pods 2′, . . . , N-1′ during one updating round of the rolling update. As shown in FIGS. 7A-7B, this embodiment can ensure that the service can be interrupted only once instead of frequent interruptions.

Although the above operations of the method 600 are described in a time sequence, not all the operations are essential for the invention. Some operations can be omitted as necessary. The method may include the operations performed at the node.

FIG. 8 depicts a computer-implemented method 800 for service rolling-updating at a node in a container orchestrator system according to an embodiment of the present invention. The method 800 includes operations S801-S804.

At S801, in response to an instruction to update a service deployed on a first pod of a plurality of pods, a second pod at the node may be created. The service is deployed on each of the plurality of pods at the node. In one embodiment, before S801, in response to receiving the set of requests, the set of requests are routed to the first pod. In one embodiment, a set of unique IDs corresponding to each of the set of requests may be generated. Each of set of unique IDs corresponds to one of the set of requests. Then the set of requests may be routed to the first pod. A correspondence relationship between the set of requests and the first pod may be recorded. In one embodiment, a correspondence relationship between the set of unique IDs and the first pod may be recorded.

At S802, a rule indicating that a set of requests for the service deployed on the first pod are to be routed to the second pod may be created. In one embodiment, the rule may include the set of IDs.

At S803, the first pod may be deleted from the node.

At S804, the set of requests may be routed to the second pod according to the rule. In one embodiment, in response to receiving one or more requests for the service, one or more unique IDs corresponding to each of the one or more requests may be generated. Each of the one or more unique IDs corresponds to one of the one or more requests. It may be determined whether at least one of the one or more unique IDs is included in the set of unique IDs. In response to determining that the at least one of the one or more unique IDs is included in the set of unique IDs, the at least one request with the at least one of the one or more unique IDs may be routed to the second pod. In this way, when one or more incoming requests including the retransmitted requests are received, the retransmitted requests can be identified. The retransmitted requests can be rerouted to the second pod.

In one embodiment, at S804, requests other than the at least one request may be routed to one or more pods according to a predetermined routing rule. In this way, the other requests may be routed to any pods according to a predetermined routing rule.

In one embodiment, after S804, in response to routing the set of requests to the second pod according to the rule, a correspondence relationship between the set of requests and the second pod may be recorded. In this way, the correspondence relationship between the set of requests and the second pod can be recorded which can be used when the second pod is to be deleted.

In one embodiment, after S804, in response to an instruction of deleting the rule, the rule may be deleted from the node.

With the above embodiments, during one updating round of the rolling update, the set of requests for the service deployed on the first pod can be rerouted to the newly created second pod. Thus, the method of present invention can make sure that the service can be interrupted only once, which can improve user experience during the service rolling-update.

It should be noted that the processing of service rolling-updating at a node in a container orchestrator system (or achieved by computing system for service rolling-updating in a container orchestrator system) according to embodiments of this invention could be implemented by computer system/server 12 of FIG. 1.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for service rolling-updating at a node in a container orchestrator system, with the node including a plurality of pods, the method comprising:
hosting a first version of a first microservice on a first pod of the plurality of pods;
receiving an instruction to update the first version of the first service to a second version of the first microservice;
in response to receipt of the instruction deploying the second version of the first microservice on a second pod of the plurality of pods;
generating, by one or more processing units, a routing rule indicating that requests for the first version of the first microservice deployed on the first pod are to be routed to the second version of the first microservice deployed on second pod;
receiving, from a client computer system and over a communication network, a first request for the first version of the first microservice deployed on the first pod; and
responsive to the receipt of the first request, applying the routing rule to instruct routing, by one or more processing units, by routing the first request to the second version of the first microservice deployed on the second pod.

2. The computer-implemented method according to claim 1, further comprising:
in response to receipt of the instruction and prior to deployment of the second version of the first microservice, creating the second pod at the node;
receiving a plurality of requests for the first version of the first microservice deployed on the first pod, the plurality of requests including the first request; and
recording a correspondence relationship between the y plurality of requests and the first pod.

3. The computer-implemented method according to claim 2, further comprising:
generating, by one or more processing units, a set of unique IDs, wherein each of the set of unique IDs corresponds to one request of the plurality of requests.

4. The computer-implemented method according to claim 3, wherein the recording of the correspondence relationship between the plurality of requests and the first pod includes recording, by one or more processing units, a correspondence relationship between the set of unique IDs and the first pod.

5. The computer-implemented method according to claim 3, wherein the routing rule includes the set of unique IDs corresponding to the plurality of requests for the first version of the first microservice.

6. The computer-implemented method according to claim 1 wherein:
the node is in the form of a virtual machine;
the first pod is a container abstraction including one or more container(s), with the container(s) included in first pod can share resources including storage and networking information including IP addresses and a range of ports; and
the second pod is a container abstraction including one or more container(s), with the container(s) included in first pod can share resources including storage and networking information including IP addresses and a range of ports.

7-20. (canceled)

21. A computer program product (CPP) comprising:
a set of storage device(s), with each storage device including a set of storage medium(s); and
computer code collectively stored in the set of storage device(s), with the computer code including data and instructions to cause a processor(s) set to perform the following operations:
hosting a first version of a first microservice on a first pod of the plurality of pods, receiving an instruction to update the first version of the first service to a second version of the first micro service,
in response to receipt of the instruction, deploying the second version of the first microservice on a second pod of the plurality of pods,
generating, by one or more processing units, a routing rule indicating that requests for the first version of the first microservice deployed on the first pod are to be routed to the second version of the first microservice deployed on second pod,
receiving, from a client computer system and over a communication network, a first request for the first version of the first micro service deployed on the first pod, and
responsive to the receipt of the first request, applying the routing rule to instruct routing, by one or more processing units, by routing the first request to the second version of the first micro service deployed on the second pod.

22. The CPP of claim 21 wherein the computer code further includes data and instructions for causing the processor(s) set to perform the following operation(s):
in response to receipt of the instruction and prior to deployment of the second version of the first microservice, creating the second pod at the node;
receiving a plurality of requests for the first version of the first microservice deployed on the first pod, the plurality of requests including the first request; and
recording a correspondence relationship between the plurality of requests and the first pod.

23. The CPP according to claim 22 wherein the computer code further includes data and instructions for causing the processor(s) set to perform the following operation(s):
generating, by one or more processing units, a set of unique IDs, wherein each of the set of unique IDs corresponds to one request of the plurality of requests.

24. The CPP according to claim 23 wherein the recording of the correspondence relationship between the plurality of requests and the first pod includes recording, by one or more processing units, a correspondence relationship between the set of unique IDs and the first pod.

25. The CPP according to claim 23 wherein the routing rule includes the set of unique IDs corresponding to the plurality of requests for the first version of the first microservice.

26. The CPP according to claim 21 wherein:
the node is in the form of a virtual machine;
the first pod is a container abstraction including one or more container(s), with the container(s) included in first pod can share resources including storage and networking information including IP addresses and a range of ports; and
the second pod is a container abstraction including one or more container(s), with the container(s) included in first pod can share resources including storage and networking information including IP addresses and a range of ports.

27. A computer system (CS) comprising:
a processor(s) set;
a set of storage device(s), with each storage device including a set of storage medium(s); and
computer code collectively stored in the set of storage device(s), with the computer code including data and instructions to cause the processor(s) set to perform the following operations:
hosting a first version of a first microservice on a first pod of the plurality of pods,
receiving an instruction to update the first version of the first service to a second version of the first micro service,
in response to receipt of the instruction, deploying the second version of the first microservice on a second pod of the plurality of pods,
generating, by one or more processing units, a routing rule indicating that requests for the first version of the first microservice deployed on the first pod are to be routed to the second version of the first microservice deployed on second pod,
receiving, from a client computer system and over a communication network, a first request for the first version of the first microservice deployed on the first pod, and
responsive to the receipt of the first request, applying the routing rule to instruct routing, by one or more processing units, by routing the first request to the second version of the first micro service deployed on the second pod.

28. The CS of claim 27 wherein the computer code further includes data and instructions for causing the processor(s) set to perform the following operation(s):
in response to receipt of the instruction and prior to deployment of the second version of the first microservice, creating the second pod at the node;
receiving a plurality of requests for the first version of the first microservice deployed on the first pod, the plurality of requests including the first request; and
recording a correspondence relationship between the plurality of requests and the first pod.

29. The CS according to claim 28 wherein the computer code further includes data and instructions for causing the processor(s) set to perform the following operation(s):
generating, by one or more processing units, a set of unique IDs, wherein each of the set of unique IDs corresponds to one request of the plurality of requests.

30. The CS according to claim 29 wherein the recording of the correspondence relationship between the plurality of requests and the first pod includes recording, by one or more processing units, a correspondence relationship between the set of unique IDs and the first pod.

31. The CS according to claim 29 wherein the routing rule includes the set of unique IDs corresponding to the plurality of requests for the first version of the first microservice.

32. The CS according to claim 27 wherein:
the node is in the form of a virtual machine;
the first pod is a container abstraction including one or more container(s), with the container(s) included in first pod can share resources including storage and networking information including IP addresses and a range of ports; and
the second pod is a container abstraction including one or more container(s), with the container(s) included in first pod can share resources including storage and networking information including IP addresses and a range of ports.
